(19) United States
(12) Patent Application Publication
(10) Pub. No.: US 2021/0267021 A1
(43) Pub. Date: Aug. 26, 2021

(54) INDUCTION HOB

(71) Applicant: ELECTROLUX APPLIANCES AKTIEBOLAG, Stockholm (SE)

(72) Inventors: Laurent JEANNETEAU, Compiègne (FR); Alex VIROLI, Forli (IT); Filippo MILANESI, Forli (IT); Andrea ROSSI, Forli (IT); Chunlong XU, Shanghai Zhejiang (CN); Adriano SCOTTO D'APOLLONIA, Forli (IT); Claudio PAOLINI, Forli (IT)

(21) Appl. No.: 17/256,709

(22) PCT Filed: Jul. 19, 2019
(86) PCT No.: PCT/EP2019/069485

§ 371 Date: Dec. 29, 2020

(30) Foreign Application Priority Data
Jul. 27, 2018 (EP) 18186053.7

(51) Int. Cl. H05B 6/06; H05B 6/12

(52) U.S. Cl. CPC H05B 6/062; H05B 2206/022; H05B 6/1263

(57) ABSTRACT

An induction hob comprising a plurality of induction coils (12, 14, 16, 18); drive circuitry (22, 24) for powering the induction coils; a user interface (26) connected with the drive circuitry; and a housing which supports the induction coils, the drive circuitry and the user interface; and characterized in that the housing comprises a bottom part (10) made of molded plastic comprising mounting means for the mounting of the induction coils (14, 16, 18, 20), the drive circuitry (22, 24) and the user interface (26).

The present invention relates to an induction hob, and in particular to an induction hob comprising a plurality of induction coils, drive circuitry for powering the induction coils, a user interface connected with the drive circuitry, and a housing which supports the induction coils, the drive circuitry and the user interface.

While induction hobs, particularly when comprising a plurality of induction coils, are quite complex structures that comprise various components, it is an object of the present invention to provide for an induction hob with plural induction coils which is easier to assemble than known induction hobs.

In an induction hob comprising a plurality of induction coils, drive circuitry for powering the induction coils, a user interface connected with the drive circuitry, and a housing which supports the induction coils, the drive circuitry and the user interface, the above object is solved by the present invention in that the housing comprises a bottom part made of molded plastic which comprises mounting means for the mounting of the induction coils, the drive circuitry and the user interface.

By providing for a housing which comprises a bottom part made of molded plastic, it is possible to provide the various mounting means for mounting the various components of the hob as integral parts of the housing, so that it no longer is required to first install mounting means, such as clamps, holders, threaded members or the like, before installing the electric components of the hob, notably the induction coils, the drive circuitry for powering the induction coils, the user interface for control of the hob, and optionally further components. Providing for a housing having a molded plastic bottom part thus not only facilitates mounting the various components but further allows reducing the overall height of the housing versus known arrangements.

The present invention can be used with advantage in induction hobs that are configured for fixed installation in a built-in kitchen, or in induction hobs which are part of a combined device comprising an oven and a hob. Such induction hobs typically comprise four cooking zones, but can comprise less or more cooking zones, which either comprise a single coil so as to provide for a cooking zone of fixed size, or which comprise two or more induction coils which selectively can be used either individually or in combination so as to provide for a variable cooking zone wherein the selected inductions coils can be controlled in combination, i.e. by a single input., so as to provide for a combined cooking zone the size and/or shape of which can be varied. The hob further may comprise cooking zones, wherein either individual coils or all coils of a first cooking zone can be used in combination with individual coils or all coils of a second cooking zone to provide for an even larger combined cooking zone to thus provide for further variability as regards the size and/or shape of the cooking zone.

Preferred embodiments of the present invention are defined in the dependent claims.

Thus, the induction hob further can comprise at least one fan for conveying air through the housing, so as to protect the components of the induction hob from overheating.

In such embodiments the housing, and particularly the bottom part thereof, preferably comprises at least one integrally formed air guide for directing air through the housing, wherein the air guides not only allow to direct cooling air to any components that are to be protected from overheating, but which also can be employed to divide the housing into a plurality of separate housing compartments to thus further provide for an optimal dissipation of heat within the housing. Thus, for example in an induction hob having a plurality of cooking zones, the housing can be divided into a corresponding number of separate housing compartments, which thus act as separate heat sinks so as to avoid that heat generated at a first induction coil is passed to a second induction coil and thus adds further heat to the heat generated by the operation of the first induction coil. Depending on the size and geometry of the induction hob and the size and location of the individual induction coils, there can be established separate housing compartments in a number that corresponds to the number of coils. If individual induction coils generate only little heat, such coil may be located in a housing compartment that is cooled exclusively by convection and thus does not require a fan, or can be located in the same housing compartment as a further induction coil so that these coils are provided with cooling air by the same fan.

Rather than providing for truly separate housing compartments in which there is no air feed from or to another housing compartment, two or more housing compartments can be configured to be vented in series, such as by providing a first housing compartment through which air is passed by a fan that may be located within such first housing compartment, wherein the air guides are configured to direct the air to a second housing compartment from which the air is vented to the atmosphere. For example in a hob having induction coils of different size and hence of different heat generation, there can be provided a fan cooled first housing compartment in which there is located a first smaller induction coil. While such first smaller induction coil involves only a moderate generation of heat, the air that is conveyed through the first housing compartment can be employed to cool a second housing compartment in which there is located a second induction coil.

While in principle the air guides can be any elements that guide an air flow into or towards a certain direction, in order to avoid interaction of the air flow with that flowing through an adjacent housing compartment, the air guides may comprise wall elements that span the height of the interior of the housing.

The housing preferably comprises cooling channels that convey air to components of the drive circuitry that require cooling. Such a cooling channel can be configured for transferring air that is supplied by a fan to a desired location within the housing where cooling is needed, i.e. as air guide channels having a certain free cross-section that serve for transferring air from the fan to components that are somewhat remote from the fan. A cooling channel further can be designed as a housing section in which there are located components to be cooled and in which there is provided for an air flow across such components. To this end, the components to be cooled can be arranged to be contacted either in parallel or serially by the air flow, such as by aligning components to be cooled and providing for air guides so that cooling air passes across these components one after the other.

When the drive circuitry comprises at least one printed circuit board having electronic components mounted thereon, the printed circuit board preferably is mounted in the housing so as to be exposed to an air stream generated by the fan. In such embodiments components of the drive circuitry that require intensive cooling can be mounted in a cut-out of the printed circuit board at a bottom side of a cooling body which thus is located on the same side of the printed circuit board as the other components. In such embodiments the electronic components thus can be cooled together with the cooling bodies of those elements that require intensive cooling, such as the power generators for the induction coils and in particular the switches, such as IGBTs, for driving the same.

To provide for additional structural stability, the housing can comprise a plurality of reinforcing ribs. With the housing and in particular the bottom part thereof in which there are supported the various components of the hob being made of molded plastic, any such reinforcing ribs can be formed integrally with the housing. Reinforcing ribs can be configured as individual ribs, i.e. as straight or curved elements that extend along a surface of the housing so as to span at least a section of the housing, or to at least partially surround an individual component or a group of components. Two or more reinforcing ribs can be arranged in an array of merging or crossing reinforcing ribs, such as a grid or honeycomb structure of reinforcing ribs. Furthermore, also some or all of the air guides can be configured as reinforcing ribs to provide additional structural stability to the housing.

In preferred embodiments, the mounting means comprise one or more snap-fit joints for mounting the induction coils, the drive circuitry, the user interface and/or one or more further elements of the induction hob. The snap-fit joints can comprise at least one of a hook, a knob, a protrusion, a bulge, or a bracket and a cooperating depression, undercut, detent, opening, edge or rim, wherein one of the elements is assigned to either the housing or an element to be mounted at the housing, and wherein the cooperating element is assigned to the other of the housing or said element to be mounted at the housing.

While snap-fit joints are preferred due to their ease of use and the fact that no additional fixing elements and tools for their assembly are required, also further or additional fixation means can be employed for mounting elements of the hob to the housing, such as screws, bolts, rivets, clamps, or the like. Alternatively, individual elements also may be glued to the housing.

The drive circuitry can comprise at least one, and preferably comprises one or two power boards, wherein each power board comprises at least one, and preferably comprises one or two power generators, wherein each power generator is associated to one induction coil. Thus, for an induction hob having four induction coils, in preferred embodiments there are provided two power boards which each comprise two power generators that are associated to the induction coils.

While preferably each induction coil is driven by one induction generator, alternatively, two of the induction coils may be connected in serial or in parallel, wherein the induction coils may be switched by relays, triacs or IGBTs (insulated gate bipolar transistors). Further, the induction coils can be driven by synchronized induction generators in order to avoid interference noise between the different induction coils.

For powering the induction coils, the drive circuitry preferably comprises quasi-resonant inverters or resonant half-bridge inverters. The drive circuitry preferably comprises at least one switching element which preferably is an Insulated Gate Bipolar Transistor (IGBT). Whereas the drive circuitry thus may comprise a resonant half-bridge inverter that uses two insulated gate bipolar transistors that are arranged in a half-bridge topology, a quasi-resonant inverter has the advantage that it requires just a single switching element such as a single insulated gate bipolar transistor.

While the housing bottom part supports the various elements of the induction hob, the housing further can comprise a top part having at least one glass-ceramic panel that covers at least one of the induction coils. Whereas there can be provided a top part having plural glass-ceramic panels that cover individual induction coils or groups of induction coils, the top part also can comprise a single glass-ceramic panel that covers all the induction coils.

In order to control the induction hob, the user interface can comprise an array of touch sensitive elements that are arranged below one of the glass-ceramic panels or below the single glass-ceramic panel. In such embodiments the touch control can be configured to operate on the basis of the infrared principle, wherein a transmitter/receiver pair is located at the bottom side of the glass-ceramic panel, wherein the transmitter provides a signal towards the glass-ceramic panel, wherein the signal that is reflected by a finger of the user is received at the receiver to thus generate a corresponding control signal.

The present invention is described in further detail below by reference to the drawings in which

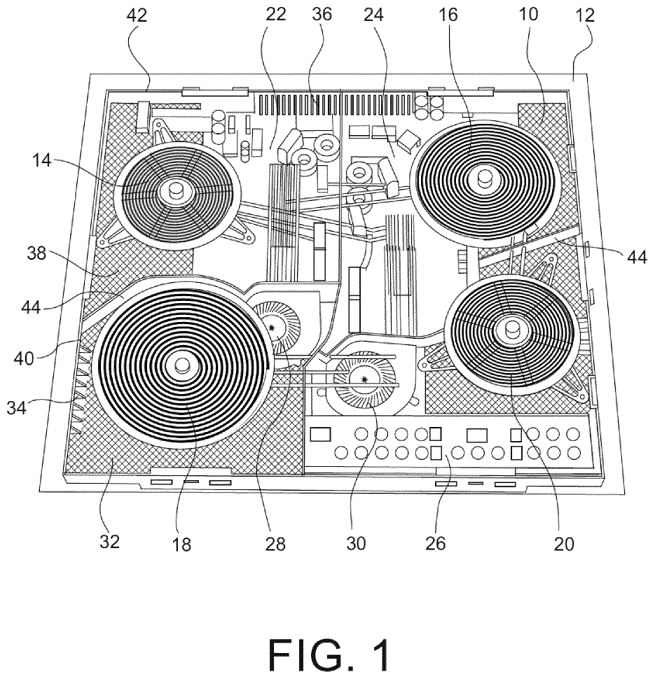

FIG. 1 illustrates a first embodiment of an induction hob in accordance with the present invention; and

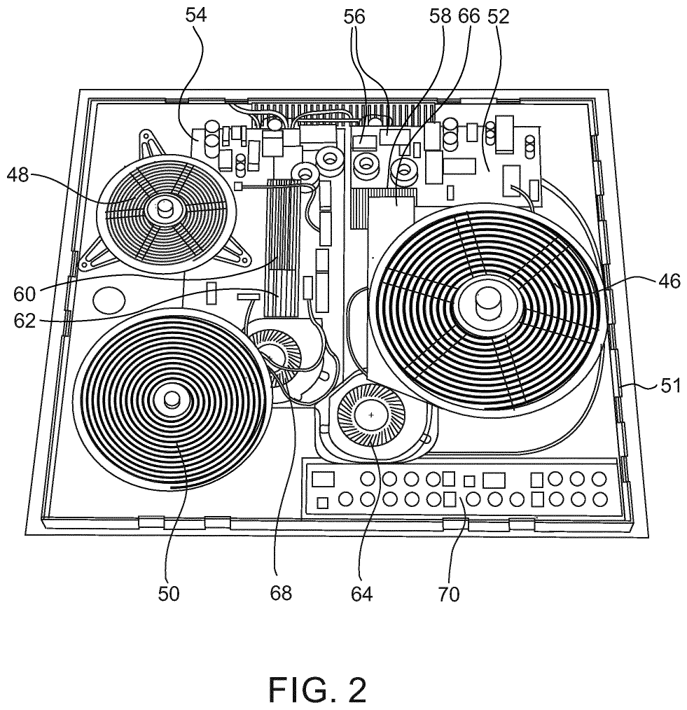

FIG. 2 illustrates a second embodiment of an induction hob in accordance with the present invention.

The induction hob illustrated in FIG. 1 comprises a housing that consists of a bottom part 10 in which there are mounted the various components of the hob and which is covered by a top part 12 which in the illustrated embodiment comprises a single glass-ceramic panel. Note that while the glass-ceramic panel comprises a tinted glass so as to block the view into the interior of the housing, for illustrative purposes top part 12 is shown in FIG. 1 as a transparent member.

Bottom part 10 is an element that is made of molded plastic in which there are integrally formed various mounting means for mounting component of the induction hob. In particular, the bottom part 10 supports four induction coils 14, 16, 18 and 20, a first and a second printed circuit board 22 and 24 with drive circuitry for powering the induction coils, a user interface 26 connected with the drive circuitry for control of the induction coils 14, 16, 18 and 20, and two fans 28 and 30 for generating cooling air streams that are conveyed through the housing.

To provide for structural stability, bottom part 10 comprises plural integrally formed reinforcing ribs, some of which are configured as an array 32 of crossing ribs that form a grid along surface areas of bottom part 10. Further reinforcing ribs 34 and 36 are provided along edge regions of bottom part 10 so as to extend between the bottom wall 38 and a side wall 40 and a back wall 42, respectively.

The housing is divided into several housing compartments by a number of air guides, which are configured as vertical wall elements 44 that span the height of the interior of the housing between bottom wall 38 and the glass ceramic panel 12. In this manner air can be conveyed from air inlets that are located below the fans, along the components of the hob to air exits which are provided in a wall section of the housing, such as in the embodiment shown in FIG. 1 an exit that is provided at the rear side in the region where the reinforcing ribs 36 are located.

In the embodiment shown in FIG. 1, the air guides divide the housing into a first housing compartment in which there is located fan 28 and induction coil 18 and from which cooling air also is passed to user interface 20 to be vented via an air exit that is located below user interface 20, a second housing compartment in which there is located fan 30 and induction coil 20, a third housing compartment in which there is located induction coil 16 and the second printed circuit board 24 and a fourth housing compartment in which there is located induction coil 14 and first printed circuit board 22.

As is illustrated in FIG. 1, depending on the temperature tolerances of the components to be cooled and their location within the housing, there can be a fan that is dedicated to just a single housing compartment, as in the illustrated embodiment applies for fan 28 which only is assigned to the first housing compartment with induction coil 18. Further there can be provided a fan that is configured to convey cooling air to more than one housing compartment, as in the illustrated embodiment applies for fan 26 which provides cooling air for the second housing compartment with induction coil 20, from which the air stream passes on into the third housing compartment with induction coil 16. Finally, there also can be provided one or more housing compartments that are cooled by convective cooling without assistance of a fan, as in the shown embodiment applies for the fourth housing compartment with induction coil 14.

In the embodiment illustrated in FIG. 2 the induction hob comprises one larger induction coil 46 and two smaller induction coils 48 and 50 which all are mounted in a common plastic housing 51. A first printed circuit board 52 comprises drive circuitry for powering the larger induction coil 46 and a second printed circuit board 54 comprises drive circuitry for powering the two smaller induction coils 48 and 50.

In both cases the drive circuitry that also is supported by housing comprises a power generator having a single Insulated Gate Bipolar Transistor (IGBT) which is arranged in a quasi-resonant configuration. In a preferred embodiment that is designed for operation at a voltage of 220 to 240 V and a frequency of 50 or 60 Hz, each power generator is designed to generate a power of up to 2.2 kW. As is illustrated in FIG. 2, whereas most of the components 56 that constitute the drive circuitry are mounted on the upper side of the printed circuit boards 52 and 54, the IGBTs which during use are heated to a considerable extent and which thus require intensive cooling, are mounted in cut-outs of the printed circuit boards 52 and 54 at the bottom side of respective cooling bodies which in FIG. 2 are illustrated as elements 58, 60 and 62.

In order to supply cooling air to the cooling body 58 mounted on the first printed circuit board 52, there is provided a first fan 64 which conveys air via a cooling channel 66 to the cooling body 58. Despite fan 64, due to spatial constraints, being located remote from the first printed circuit board 52, by the aid of cooling channel 66 first fan 64 is able to provide sufficient cooling air to the first printed circuit board 52 and in particular to the cooling body 58 of the IGBT that drives induction coil 46.

Second printed circuit board 54 is cooled by a second fan 68 which in the embodiment illustrated in FIG. 2 is located in direct proximity to the second printed circuit board 54. Considering that most of the cooling is required for cooling the IGBTs for switching induction coils 48 and 50, second fan 68 is configured to direct air to cooling body 62, at the bottom side of which there is mounted the IGBT for induction coil 50. Note that cooling body 60 at the bottom side of which there is mounted the IGBT for induction coil 48 is located in alignment with second fan 68 and cooling body 62, so that the air stream that is generated by the second fan 68 after having passed over cooling body 62 flows over cooling body 60.

Similarly as in the embodiment illustrated in FIG. 1, a user interface 70 is provided in a front part of the housing 51. User interface 70 is connected with the printed circuit boards 52 and 54 and comprises various input and display elements for control of the induction coils 46, 48 and 50.

By the provision of a plastic housing that supports all the main hob components, such as the induction coils, the fans, the power electronics, and the user interface, several advantages are achieved over conventional induction hobs.

Thus, the manufacturing of the hob can be substantially facilitated because the various mounting means for fixing the components of the hob can be configured as integral parts of the housing, wherein such mounting means further can be designed as snap-in connections that do not rely on any separate fixing members such as screws and the like.

Furthermore, as the plastic housing allows to design the hob to have no metal parts on the outer part of the hob, an earth connection as it is required in conventional hobs can be omitted, which not only further facilitates assembly and complexity of the hob, but which also results in a reduced emission of electromagnetic noise and, as a consequence, in reduced costs for the EMC filter circuit which usually is provided in electric devices such as induction hobs.

In the induction hob suggested herein, the reinforcing ribs and the air guides that provide for the multi-function of providing for stability to the housing, dividing the housing into several separate heat sink compartments, and guiding the cooling air from the fans to any components to be cooled, result in a robust design of the plastic housing that avoids bending of the housing despite the fact that due to the provision of a plurality of induction coils the housing inherently has a relatively large surface area.

### REFERENCE SIGNS

10 bottom part (plastic housing part)
12 top part (glass-ceramic panel)
14 induction coil
16 induction coil
18 induction coil
20 induction coil
22 first printed circuit board
24 second printed circuit board
26 user interface
28 fan
30 fan
32 array of reinforcing ribs
34 reinforcing ribs
36 reinforcing ribs
38 bottom wall
40 side wall
42 rear wall
44 air guide
46 induction coil
48 induction coil
50 induction coil
51 housing
52 first printed circuit board
54 second printed circuit board
56 PCB components
58 cooling body
60 cooling body
62 cooling body
64 first fan
66 cooling channel
68 second fan
70 user interface

1. An induction hob comprising:
a plurality of induction coils;
drive circuitry for powering the induction coils;
a user interface connected with the drive circuitry; and
a housing which supports the induction coils, the drive circuitry and the user interface;
the housing comprising a bottom part made of molded plastic comprising mounting means for the mounting of the induction coils, the drive circuitry and the user interface.

2. The induction hob of claim 1, comprising at least one fan for conveying air through the housing.

3. The induction hob of claim 2, wherein the housing comprises at least one integrally formed air guide for directing air through the housing.

4. The induction hob of claim 3, wherein the housing comprises one or more air guides that divide the housing into a plurality of separate housing compartments.

5. The induction hob of claim 4, wherein the one or more air guides comprise wall elements that span a height of an interior of the housing.

6. The induction hob of claim 2, wherein the housing comprises cooling channels that convey air to components of the drive circuitry that require cooling.

7. The induction hob of claim 2, wherein the drive circuitry comprises at least one printed circuit board having electronic components mounted thereon, wherein the printed circuit board is mounted in the housing so as to be exposed to an air stream generated by the at least one fan.

8. The induction hob of claim 1, wherein components of the drive circuitry that require intensive cooling are mounted in a cut-out of the printed circuit board at a bottom side of a cooling body.

9. The induction hob of claim 8, wherein components of the drive circuitry that require intensive cooling are mounted on the printed circuit board so as to be aligned to an air stream that is conveyed across the printed circuit board.

10. The induction hob of claim 1, wherein the housing comprises a plurality of reinforcing ribs.

11. The induction hob of claim 1, wherein the mounting means comprises at least one snap-fit joint for mounting the induction coils, the drive circuitry, the user interface and/or a further element of the induction hob.

12. The induction hob of claim 11, wherein the at least one snap-fit joint comprises at least one of a hook, a knob, a protrusion, a bulge, or a bracket and a cooperating depression, undercut, detent, opening, edge or rim.

13. The induction hob of claim 1, wherein the drive circuitry comprises one or two power boards, each said power board comprising one or two power generators, each said power generator being associated to one induction coil.

14. The induction hob of claim 1, wherein the drive circuitry comprises at least one quasi-resonant inverter.

15. The induction hob of claim 1, wherein the drive circuitry comprises a resonant half-bridge inverter.

16. The induction hob of claim 1, wherein the drive circuitry comprises at least one switching element which is an Insulated Gate Bipolar Transistor.

17. The induction hob of claim 1, wherein the housing comprises a top part having at least one glass-ceramic panel that covers at least one of the induction coils.

18. The induction hob of claim 17, wherein the top part comprises a single glass-ceramic panel that covers all the induction coils.

19. The induction hob of claim 18, wherein the user interface comprises an array of touch sensitive elements that are arranged below the single glass-ceramic panel.

20. An induction hob comprising: a housing comprising a molded plastic bottom part comprising integrally formed first, second, third and fourth snap-in connections, and a glass-ceramic panel disposed above the molded plastic bottom part, a first induction coil mounted to said plastic bottom part via said first snap-in connection, a printed circuit board having driving circuitry configured to drive said induction coil mounted to said plastic bottom part via said second snap-in connection, a second induction coil mounted to said plastic bottom part via said third snap-in connection, and a user interface connected with the driving circuitry and mounted to said plastic bottom part via said fourth snap-in connection, at least one air guide provide as one or a plurality of vertical walls integrally formed with said molded plastic bottom part and extending therefrom up to an underside surface of said glass-ceramic panel to thereby define and at least partially isolate from one another first and second compartments of said housing, said first induction coil and said printed circuit board being disposed in the first compartment and said second induction coil being disposed in the second compartment, said fan being configured to direct a flow of cooling air within said first compartment over electronic components of said printed circuit board and thereafter into said second compartment, a plurality of first reinforcing ribs being formed integrally and arranged in a crossing-pattern array in a bottom wall of said plastic bottom part, and a plurality of second reinforcing ribs being formed integrally with said plastic bottom part and extending between the bottom wall thereof and at least one of a vertical wall or a side wall thereof, said user interface comprising an array of touch sensitive elements arranged below the glass-ceramic panel and actuable by a user touching an upper surface of the glass ceramic panel, said induction hob omitting separate fasteners for securing any of the first or second induction coils, the printed circuit board or the user interface to the housing, said housing possessing no metal at its exterior surface and thus omitting any earth connection configured to electrically ground the housing.
